(19) United States
(12) Patent Application Publication
(10) Pub. No.: US 2010/0304039 A1
(43) Pub. Date: Dec. 2, 2010

(54) PROCESSING DEVICE AND METHOD FOR COATING A RUDDER UNIT OF AN AIRCRAFT

(75) Inventors: Dirk BAUSEN, Harsefeld (DE); Daniel LAHIDJANIAN, Hamburg (DE); Birgit KUHLENSCHMIDT, Hamburg (DE); Karl HAUSMANN, Hamburg (DE); Rolf BENSE, Jork (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: AIRBUS DEUTSCHLAND GMBH, Hamburg (DE)

(21) Appl. No.: 12/788,919

(22) Filed: May 27, 2010

Related U.S. Application Data
(60) Provisional application No. 61/181,370, filed on May 27, 2009.

(30) Foreign Application Priority Data
May 27, 2009 (DE) 10 2009 022 795.4

(51) Int. Cl. C08F 2/46; B05C 13/02

(52) U.S. Cl. 427/488; 118/72

(57) ABSTRACT

A processing device for coating a surface of a rudder unit of an aircraft includes a plurality of spatially delimited work stations, wherein each of the plurality of work stations are disposed in succession and are configured to produce an assembly line-like coating process, wherein the plurality of work stations. The work stations include a pretreating station configured to activate the surface so as to form an activated surface; a painting station disposed downstream of the pretreating station and configured to paint the activated surface with at least one layer of paint having a first color so as to form a painted surface and configured to dry the painted surface immediately after the painting; and a decorating station.

### CROSS REFERENCE TO PRIOR APPLICATIONS

Priority is claimed to German Patent Application No. DE 10 2009 022 795.4, filed May 27, 2009 and to U.S. Provisional Application No. 61/181,370, filed May 27, 2009. The entire disclosure of both applications is incorporated by reference herein.

The invention pertains to a processing device for coating a tail assembly of an aircraft, the surface of which was already primed in preparation. Furthermore, the invention also pertains to a method for operating such a processing device.

The field of application of the present invention concerns the construction of aircraft, particularly the manufacture of larger types of aircraft for transporting passengers and cargo. Such aircraft feature wings that are laterally arranged on a large-volume fuselage, as well as an elevator and rudder unit on the tail end. The rudder unit, in particular, has a relatively large surface in a side view of an aircraft of the presently interesting type, wherein this large surface usually serves for applying lettering, picture motifs and other identifying or artistic motifs. This requires special manufacturing steps during the course of the surface coating of an aircraft being manufactured, wherein these manufacturing steps need to be exactly adapted to one another with respect to content and time in order to ensure an efficient manufacture.

### BACKGROUND

WO 2006/026240 A1 discloses a processing device for coating a rudder unit. A graphic picture motif is automatically applied onto a ready-painted surface by means of a robot. The rudder unit is held in the upright position by a carrier platform. A gantry robot is arranged to both sides of the rudder unit, wherein the three movable spatial axes of said gantry robot move an application head with a plurality of fluid nozzles for pigmented ink in accordance with a control so as to apply the desired motif. In this case, a vacuum holding device serves for the distance control between the application head and the curved surface of the rudder unit.

In such a decoration of the rudder unit, the quality of the applied letter or picture motif depends on the previously applied paint. This paint needs to be sufficiently dry and also cannot be covered with a dust layer or other contaminants that would require another surface cleaning prior to the decorating step.

### SUMMARY OF THE INVENTION

An aspect of the present invention is to develop a processing device and a method for coating the rudder unit of an aircraft which allow a high manufacturing quality for a decoration with a letter or picture motif within a minimal manufacturing time.

The invention includes the process technology characteristic of carrying out a coating process similar to an assembly line by providing several successive and spatially delimited work stations that comprise a pretreating station for at least the surface activation of the sanded surface of the rudder unit, a downstream painting station for painting the activated surface with at least one layer and for drying the painted surface immediately thereafter, as well as a downstream decorating station for applying letter and/or picture motifs of contrasting color referred to the paint.

An advantage of the inventive solution can be seen, in particular, in that the directly adjacent arrangement of the work stations makes it possible to realize the entire process in an automated fashion such that no intermediate storage is required. Since an intermediate storage would require special covering measures for protecting the surfaces from dust, the manufacturing expenditures are reduced accordingly with the inventive assembly line-like processing device. Due to the automation, the complete final painting with a decoration can be realized within standardized cycle times depending on the letter or picture motif to be applied. In addition, the emissions of paints and solvents are minimized and the concentration of the processing space achieved with the inventive processing device contributes to energy savings, as well as to improving the surface quality.

According to one measure partition walls with movable door elements may be provided for spatially delimiting the adjacent cabin-shaped work stations. In order to completely seal off, in particular, the painting station relative to the environment, this painting station can be designed such that it is closed on all sides and therefore has a closed cabin-like shape. The door elements are arranged on opposite lateral surfaces of the work station and preferably realized in the form of roller shutters. When a rudder unit is transported into the work station or—after its completion—transported out of the work station, it suffices to briefly open the door elements in order to advance the rudder unit by one work cycle such that hardly any dust is admitted into the work station or—vice versa—hardly any solvent vapors escape from the work station into the surroundings.

In order to realize an unobstructed transport of the rudder unit from work station to work station, it is proposed in accordance with another measure that enhances the invention to provide a continuous work floor that connects the adjacent work stations and is provided with transport rails that extend parallel to one another, wherein the rudder unit preferably can be moved along said transport rails on a mobile holding device. The mobile holding device may be realized similar to a rolling truck and maintains a defined moving direction due to the guide rails such that a rudder unit transported into a work station can always be identically positioned relative to the work equipment arranged therein with simple means and minimal adjusting effort.

It suffices if the carriage-like holding device is manually displaced between the work stations. After the nominal position is reached, brakes serve for fixing the exact position relative to the work station. However, it would also be conceivable to equip the carriage-like holding device with an auxiliary motor in order to transport the rudder unit between the work stations in a power-assisted fashion. In this case, it is appropriate to synchronize the control for the auxiliary motors of the holding devices of all work stations in order to simultaneously advance all rudder units situated in the work stations by one work cycle. Alternatively, an auxiliary motor may also be arranged on the rails, for example, in the frame of a chain conveyor or the like.

The inventive processing device that serves for realizing an efficient coating cycle may be fitted with different work equipment. For example, it is proposed to respectively equip all work stations with a work platform to both sides of the rudder unit. The work platforms enable the specialized personnel to reach the entire surface of the rudder unit to be processed in order to carry out, in particular, manual cleaning tasks, masking tasks and the like. This measure serves for the quality assurance because a rudder unit of presently interesting commercial aircraft frequently has an areal extent of several meters. The work platforms preferably should be adjustable with respect to their height in a hydraulic or electromotive fashion, wherein the specialized personnel can activate the work platforms from a control panel or the like.

It is furthermore proposed to equip each work station with a robot, preferably a gantry robot, for automatically processing the surface of the rudder unit in addition to such a work platform or alternatively to a work platform. The robot serves, in particular, for carrying out difficult and harmful production steps such as the painting or the drying process. For this purpose, the robot moves a spray head or a radiant infrared dryer or the like. A tool change can also be automated in this case. The utilization of a robot ensures a high manufacturing quality, particularly during the painting and decorating steps, such that defined layer thicknesses can be easily observed and the formation of runs during the painting process and other manual influential factors can be precluded.

Depending on the product requirements or customer specifications, various processing steps that are discussed in greater detail below can be flexibly carried out in the individual work stations.

At least a surface activation of the rudder unit surface takes place in the pretreating station. The rudder unit is already primed and sanded. The surface activation is preferably carried out by means of plasma and serves for preparing the surface for the subsequent painting step. An optional cleaning of the surface may also be carried out within the pretreating station prior to the surface activation. After the surface activation by means of plasma, the surface can—depending on the properties of the paint—be precoated with a primer that serves for promoting the adhesion of the paint to be subsequently applied. In addition, a manual masking of the components of the rudder unit that should not be coated such as, for example, actuators, hinges and the like can also be carried out within the pretreating station. This is preferably realized in the form of conventional masking with foils or adhesive tape.

The painting station that follows the pretreating station primarily serves for painting the pretreated surface of the rudder unit with multiple layers. In this respect, the paint includes a base paint that defines the color of the surface. After the base paint is at least dry to the touch, a clear paint is applied in order to protect the paint from erosion and to simultaneously produce a glossy surface. An infrared paint drying process is carried out within the painting station immediately after the painting process. For this purpose, infrared emitters that reach the entire surface area of the rudder unit are installed at suitable locations within the painting station.

The decorating station that follows the painting station primarily serves for applying a letter or picture motif onto the painted surface. This is preferably realized in the form of masked spray painting. For this purpose, the surface preferably is manually masked and a paint of contrasting color referred to the base paint is subsequently sprayed on. The masking is ultimately removed again and a paint drying process is carried out, preferably also with infrared emitters.

An advantage of the above-described method with its individual processing steps can be seen, in particular, in that the processing times within each work station can be coordinated and optimized in order to achieve an altogether shorter cycle time. The inventive method simultaneously opens up a broad layout variety with respect to letter and picture motifs that can be realized on the surface of a rudder unit.

### BRIEF DESCRIPTION OF THE DRAWINGS

Other measures that enhance the invention are discussed in greater detail below in connection with the description of one preferred exemplary embodiment of the invention that refers to the figures. In the drawings:

FIG. 1 shows a schematic representation of a processing device for coating a rudder unit with three work stations, and

FIG. 2 shows a flow chart of the sequence of processing steps of the processing device of FIG. 1.

### DETAILED DESCRIPTION

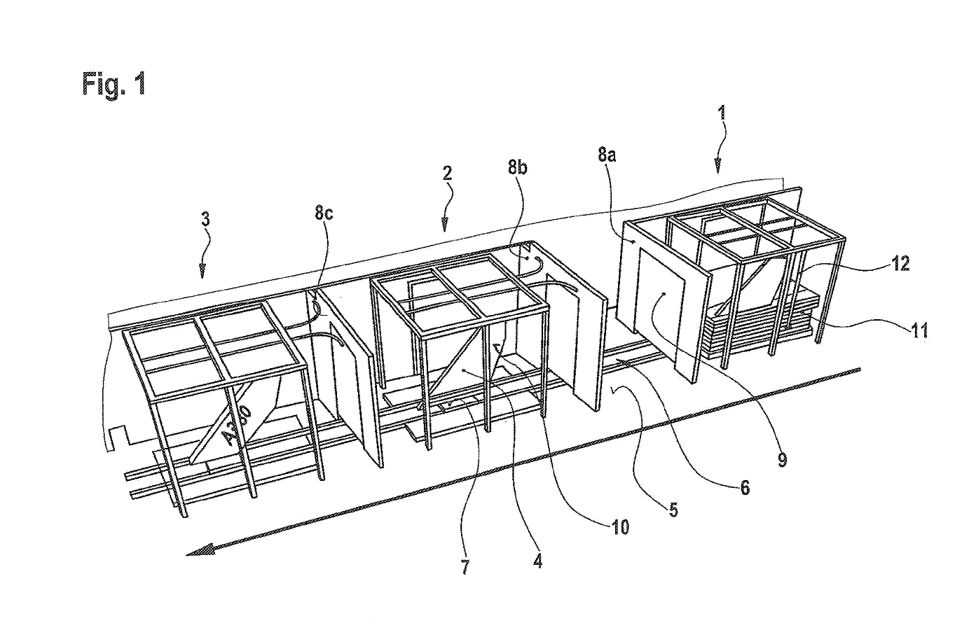

According to FIG. 1, the processing device essentially consists of three adjacent work stations, namely a pretreating station 1 on the entry side, a downstream painting station 2 and a decorating station 3 on the exit side. A rudder unit 4 is cyclically transported from work station to work station in the moving direction indicated by an arrow. For this purpose, parallel transport rails 6 are recessed into the work floor 5, wherein a mobile holding device 7 for the rudder unit 4 is arranged on said transport rails. In this exemplary embodiment, the movement of the rudder unit 4 from work station the work station is realized manually.

In order to spatially delimit the adjacent work stations, partition walls 8a to 8c are provided that respectively feature (exemplary) door elements 9. The door elements 9 are realized in the form of roller shutters and simultaneously opened during the movement of the rudder units 4 between the work stations.

In order to coat the surface 10 of the rudder unit 4 on both sides in an assembly line-like fashion, at least a surface activation of the sanded surface 10 is carried out within the pretreating station 1. Furthermore, a manual cleaning process is also carried out. For this purpose, the pretreating station 1, as well as the downstream painting station 2 and the decorating station 3, are respectively equipped with a work platform 11 to both sides of the rudder unit 4. In this exemplary embodiment, the work platform 11 can be manually adjusted with respect to its height by means of hydraulic actuators such that the specialized personnel is able to reach the entire surface 10 to be processed. A gantry robot 12 is respectively installed in each work station behind the work platform 11 and carries out the automatic processing steps in each work station. With respect to the pretreating station 1, the automatic processing step consists of spraying on a primer. The gantry robot 12 has three linear axes that correspond to the spatial axes and can be adjusted orthogonally to one another in accordance with a control. The gantry robot 12 is able to reach the entire area of the surface 10 of the rudder unit 4. Depending on the processing step, a tool change, for example, between different spray heads may also be carried out.

In the painting station 2 that follows the pretreating station 1, the surface 10 is painted with multiple layers, namely with a base paint and then with a clear paint. A paint drying process is carried out after each painting step by means of an infrared emitter. The painting processes within the painting station 2 are essentially carried out in a robot-assisted fashion.

In the decorating station 3 that follows the painting station 2, the painted surface 10 of the rudder unit 4 is masked in order to subsequently apply the letter or picture motifs thereon by means of spray painting. The masking is removed again prior to the curing of the paint and the drying process is also carried out with infrared emitters in this case.

All above-described work stations are realized in a closed, cabin-like fashion in order to prevent the admission of dust particles and the like, as well as to protect the environment from escaping solvent vapors and the like.

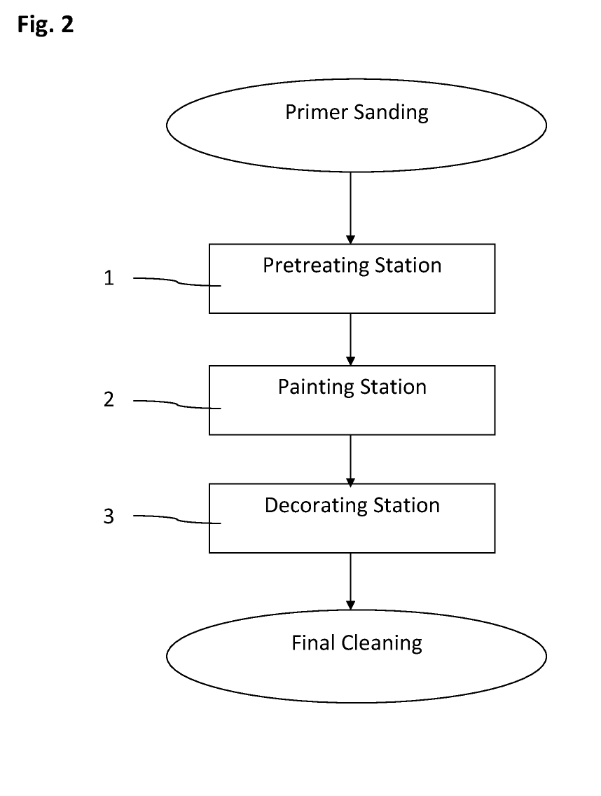

FIG. 2 basically shows the coating method carried out by means of the above-described processing device. In the initial phase, a rudder unit with sanded primer is placed into the pretreating station 1. At least a surface activation is carried out within the pretreating station 1. In the downstream painting station 2, the activated surface of the rudder unit is painted with multiple layers immediately thereafter—i.e., without intermediate storage—in order to apply the desired letter or picture motif of contrasting color referred to the surface paint onto the painted surface of the rudder unit during the last processing step within a downstream decorating station 3. After each painting step, a drying process is carried out by means of infrared irradiation. If the paint should only be applied in a locally limited fashion, it is required to carry out a manual intermediate step in the form of a masking step realized with a foils and/or adhesive tape.

As a supplement, it should be noted that “comprising” does not exclude other elements or steps, and that “an” or “a” does not exclude a plurality. It should furthermore be noted that characteristics or steps that were described with reference to one of the above exemplary embodiments can also be used in combination with other characteristics or steps of other above-described exemplary embodiments. Reference symbols in the claims should not be interpreted in a restrictive sense.

### LIST OF REFERENCE SYMBOLS

1 Pretreating station
2 Painting station
3 Decorating station
4 Rudder unit
5 Work floor
6 Transport rails
7 Holding device
8 Partition wall
9 Door element
10 Surface
11 Work platform
12 Gantry robot

What is claimed is:

1. A processing device for coating a surface of a rudder unit of an aircraft, the device comprising:
a plurality of spatially delimited work stations disposed in succession so that the rudder unit can be moved to each work station in succession, wherein the plurality of work stations includes:
a pretreating station configured to activate the surface so as to form an activated surface;
a painting station disposed downstream of the pretreating station and configured to paint the activated surface with at least one layer of paint having a first color so as to form a painted surface and configured to dry the painted surface after the painting; and
a decorating station disposed downstream of the painting station and configured to apply a pattern having a second color different from the first color, wherein the pattern includes at least one of a letter and a picture motif.

2. The processing device as recited in claim 1, wherein each of the plurality of work stations includes at least one partition wall having a movable door element.

3. The processing device as recited in claim 1, further comprising a continuous work floor connecting each of the plurality of work stations and a plurality of parallel transport rails configured to move the rudder unit to each of the plurality of work stations.

4. The processing device as recited in claim 1, further comprising a mobile holding device for the rudder unit disposed on the parallel transport rails.

5. The processing device as recited in claim 4, further comprising an auxiliary motor drive configured to displace the mobile holding device between the plurality of work stations.

6. The processing device as recited in claim 1, wherein the plurality of work stations each include a work platform disposed on a first side and a second side of the rudder unit configured to enable a manual processing of the surface.

7. The processing device as recited in claim 6, wherein a height of the work platform is electromotively or hydraulically adjustable such that the entire rudder unit is reachable.

8. The processing as recited in claim 1, further comprising a gantry robot disposed in each work station on each side of the rudder unit configured to automatically process the surface of the rudder unit.

9. A method for coating a surface of a rudder unit of an aircraft, the method comprising:
moving the rudder unit to a pretreating station;
activating the surface of the rudder unit in the pretreating station so as to form an activated surface;
moving the rudder unit to a painting station;
painting the activated surface with at least one layer of paint having a first color in the painting station so as to form a painted surface;
drying the painted surface after the painting in the painting station;
moving the rudder unit into a decorating station; and
applying a pattern having a second color different from the first color in the decorating station, wherein the pattern includes at least one of a letter and a picture motif.

10. The method as recited in claim 9, further comprising cleaning the surface in the pretreating station prior to the activating and precoating the activated surface with a primer in the pretreating station so as to promote adhesion of the at least one layer of paint, wherein the activating is performed using a plasma.

11. The method as recited in claim 9, further comprising applying a protective clear paint in the painting station after the painting step and wherein the drying includes drying the painted surface using infrared drying.

12. The method as recited in claim 9, wherein the applying of the pattern is performed using masked spray painting and further comprising subsequently covering the pattern with a clear protective paint in the decorating station.
